(19) United States
(12) Patent Application Publication
(10) Pub. No.: US 2009/0300282 A1
(43) Pub. Date: Dec. 3, 2009

(54) REDUNDANT ARRAY OF INDEPENDENT DISKS WRITE RECOVERY SYSTEM

(75) Inventor: Mohan B. Rowlands, Union City, CA (US)

Correspondence Address: LAW OFFICES OF MIKIO ISHIMARU, 333 W. EL CAMINO REAL, SUITE 330, SUNNYVALE, CA, 94087, US

(73) Assignee: PROMISE TECHNOLOGY, INC., Milpitas, CA (US)

(21) Appl. No.: 12/131,021

(22) Filed: May 30, 2008

(51) Int. Cl. G06F 12/00

(52) U.S. Cl. 711/114; 711/E12.001

(57) ABSTRACT

A redundant array of independent disks write recovery system includes: providing a logical drive having a disk drive that failed; rebooting a storage controller, coupled to the disk drive, after a controller error; and reading a write hole table, in the storage controller, for regenerating data on the logical drive.

### TECHNICAL FIELD

The present invention relates generally to storage systems, and more particularly to a system for recovering from an incomplete write of a Redundant Array of Independent Disks (RAID) storage system that has suffered a first failure.

### BACKGROUND ART

Every industry has critical data that must be protected. There are massive amounts of information that is collected every day. Banks, insurance companies, research firms, technical industries, and entertainment companies, just to name a few, create volumes of data daily that can have a direct impact on our lives. Protecting and preserving this data is a requirement to staying in business.

Various storage mechanisms are available that use multiple storage devices to provide data storage with improved performance and reliability than an individual storage device. For example, a Redundant Array of Independent Disks (RAID) system includes multiple disks that store mission critical data. RAID systems and other storage mechanisms using multiple storage devices provide improved reliability by using parity data. Parity data allows a system to reconstruct lost data if one of the storage devices fails or is disconnected from the storage mechanism.

Several techniques are available that permit the reconstruction of lost data. One technique reserves one or more storage devices in the storage mechanism for future use if one of the active storage devices fails. The reserved storage devices remain idle and are not used for data storage unless one of the active storage devices fails. If an active storage device fails, the missing data from the failed device is reconstructed onto one of the reserved storage devices. A disadvantage of this technique is that one or more storage devices are unused unless there is a failure of an active storage device. Thus, the overall performance of the storage device is reduced because available resources (the reserved storage devices) are not being utilized. Further, if one of the reserved storage devices fails, the failure may not be detected until one of the active storage devices fails and the reserved storage device is needed.

Another technique for reconstructing lost data uses all storage devices to store data, but may reserve a specific amount of space on each storage device or spare unused drives may be available in case one of the storage devices fails. Using this technique, the storage mechanism realizes improved performance by utilizing all of the storage devices while maintaining space for the reconstruction of data if a storage device fails. In this type of storage mechanism, data is typically striped across the storage devices. This data striping process spreads data over multiple storage devices to improve performance of the storage mechanism. The data striping process is used in conjunction with other methods (e.g., parity data) to provide fault tolerance and/or error checking. The parity data provides a logical connection that relates the data spread across the multiple storage devices.

A problem with the above technique arises from the logical manner in which data is striped across the storage devices. To reconstruct the data from a failed storage device and store that data in the unused space on the remaining storage devices, the storage mechanism may be required to relocate all of the data on all of the storage devices (i.e., not just the data from the failed storage device). Relocation of all data in a data stripe is time consuming and uses a significant amount of processing resources. Rebuilding the data in a spare drive may also require a significant amount of processing resource, but may present less risk in the face of a second failure of the system. Additionally, input/output requests by host equipment coupled to the storage mechanism are typically delayed during this relocation of data, which is disruptive to the normal operation of the host equipment.

All of these efforts to protect the data may be thwarted by a second failure of the system. If a power failure interrupts a write of the data to the storage system that has already suffered a disk failure, the critical data may be lost.

Thus, a need still remains for a redundant array of independent disks write recovery system to provide an improved system and method to reconstruct data in a storage mechanism that contains multiple storage devices. In view of the ever-increasing amount of mission critical data that must be maintained, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to save costs, improve efficiencies and performance, and meet competitive pressures, adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a redundant array of independent disks write recovery system including: providing a logical drive having a disk drive that failed; rebooting a storage controller, coupled to the disk drive, after a controller error; and reading a write hole table, in the storage controller, for regenerating data on the logical drive.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is a functional block diagram of a RAID write recovery system, in an embodiment of the present invention;

FIG. 2 is a functional block diagram of a computer system with a storage subsystem;

FIG. 3 is a block diagram of a RAID 5 configuration of the data storage system, of FIG. 2;

FIG. 4 is a block diagram of a RAID 6 configuration of the data storage system, of FIG. 2;

FIG. 5 is a flow chart of a critical logical drive write process for the RAID 5 configuration or the RAID 6 configuration;

FIG. 6 is a flow chart of a write hole table flush process for the critical logical drive; and

FIG. 7 is a flow chart of a redundant array of independent disks write recovery system for operating the redundant array of independent disks write recovery system in an embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the system are semi-diagrammatic and not to scale and, particularly, some of the dimensions are for the clarity of presentation and are shown greatly exaggerated in the drawing FIGs. Where multiple embodiments are disclosed and described, having some features in common, for clarity and ease of illustration, description, and comprehension thereof, similar and like features one to another will ordinarily be described with like reference numerals.

For expository purposes, the term “horizontal” as used herein is defined as a plane parallel to the plane or surface of the Earth, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane. The term “on” means there is direct contact among elements. The term “system” as used herein means and refers to the method and to the apparatus of the present invention in accordance with the context in which the term is used.

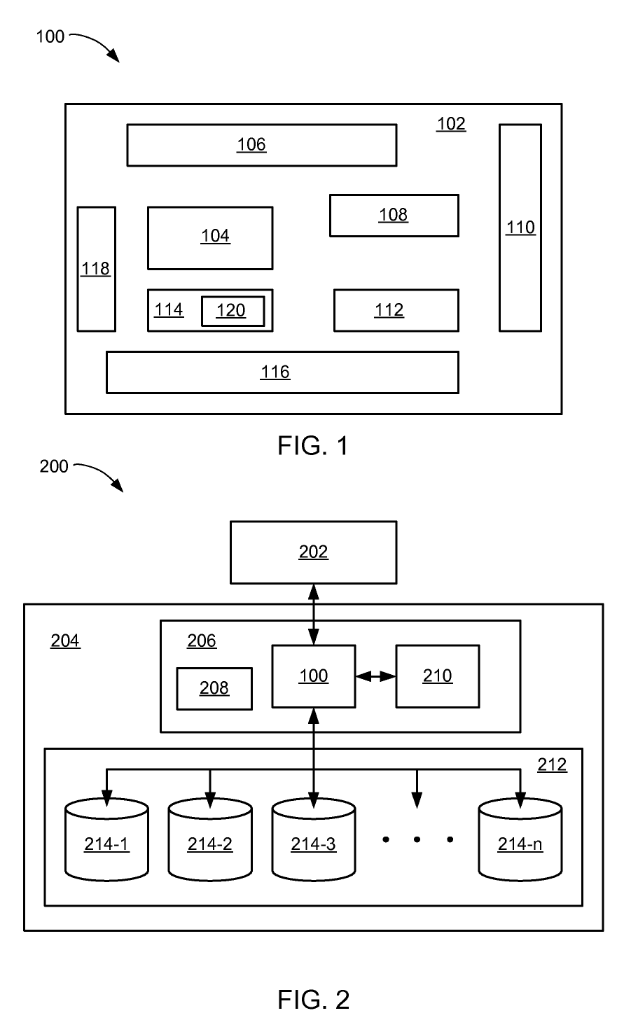

Referring now to FIG. 1, therein is shown a functional block diagram of a RAID write recovery system 100, in an embodiment of the present invention. The functional block diagram of the RAID write recovery system 100 depicts an electronics substrate 102, such as a semiconductor substrate, a package substrate, or a printed circuit board, having a processor 104, a host computer interface 106, a RAM input/output cache file (RIO) 108, a memory interface 110, an XOR engine 112, a non-volatile memory 114, a storage system interface 116, and a battery back-up interface 118.

An operation to the RAID (not shown) may be initiated through the host computer interface 106. The host computer interface 106 may interrupt the processor 104 to execute the command from the host computer interface 106 or to set-up a status response within the host computer interface 106 for transfer. The processor 104 may prepare the memory interface 110 to receive a data transfer from the host computer interface 106. The processor 104, upon receiving a status from the host computer interface 106 that the data has been received, may retrieve a cache-line of the data and write it to the RIO 108 in preparation for a transfer of the data to the storage system interface 116. The RIO 108 may be a non-volatile memory device or a volatile memory device supported by the battery back-up interface 118.

The processor 104 may set or read status bits in the non-volatile memory 114 in order to provide a recovery check point in the event of a failure. If a power related failure occurs, the battery back-up interface 118 may provide sustaining power to the RIO 108, the memory interface 110 or a combination thereof. The battery back-up interface 118 may provide sufficient energy to prevent data loss for a limited time, in the range of 60 to 80 hours and may typically provide 72 hours of protection.

The non-volatile memory 114 may contain information about the physical environment beyond the host computer interface 106, the memory interface 110 and the storage system interface 116. The non-volatile memory 114 may also retain information about the current status or operational conditions beyond the host computer interface 106 and the storage system interface 116, such as a write hole table 120.

The write hole table 120 may be used to retain information about a pending write command during a controller failure, such as a power failure. This information may include command parameters, location of the data, and logical drive destination. The information may be stored, in the write hole table 120, prior to the execution of a write command and may be removed at the completion of the write command. If any information is detected in the write hole table 120 during a boot-up, the stripe group belonging to that group will be made consistent by re-computing the parity and writing the parity alone.

The XOR engine 112 may provide a high speed logic for calculating parity of a data stripe. The XOR engine 112 may also be used to regenerate data for a failed storage device (not shown).

Referring now to FIG. 2, therein is shown a block diagram of an embodiment of a computer system 200 according to an embodiment of the present invention. The computer system 200 has one or more independently or co-operatively operated host computers represented by a host computer system 202.

The host computer system 202 may be connected to a data storage system 204, which in the present embodiment is a redundant array of independent disks (RAID) system. The data storage system 204 includes one or more independently or co-operatively operating controllers represented by a storage controller 206. A battery back-up 208 may be present on the controller system.

The storage controller 206 generally contains the RAID write recovery system 100 and a memory 210. The RAID write recovery system 100 may process data and executes programs from the memory 210.

The RAID write recovery system 100 may be connected to a storage subsystem 212, which includes a number of storage units, such as disk drives 214-1 . . . n. The RAID write recovery system 100 processes data between the host computer system 202 and the disk drives 214-1 . . . n.

The data storage system 204 provides fault tolerance to the host computer system 202, at a disk drive level. If one of the disk drives 214-1 . . . n fails, the storage controller 206 can typically rebuild any data from the one failed unit of the disk drive 214-1 . . . n onto any surviving unit of the disk drives 214-1 . . . n. In this manner, the data storage system 204 handles most failures of the disk drives 214-1 . . . n without interrupting any requests from the host computer system 202 or reporting unrecoverable data status.

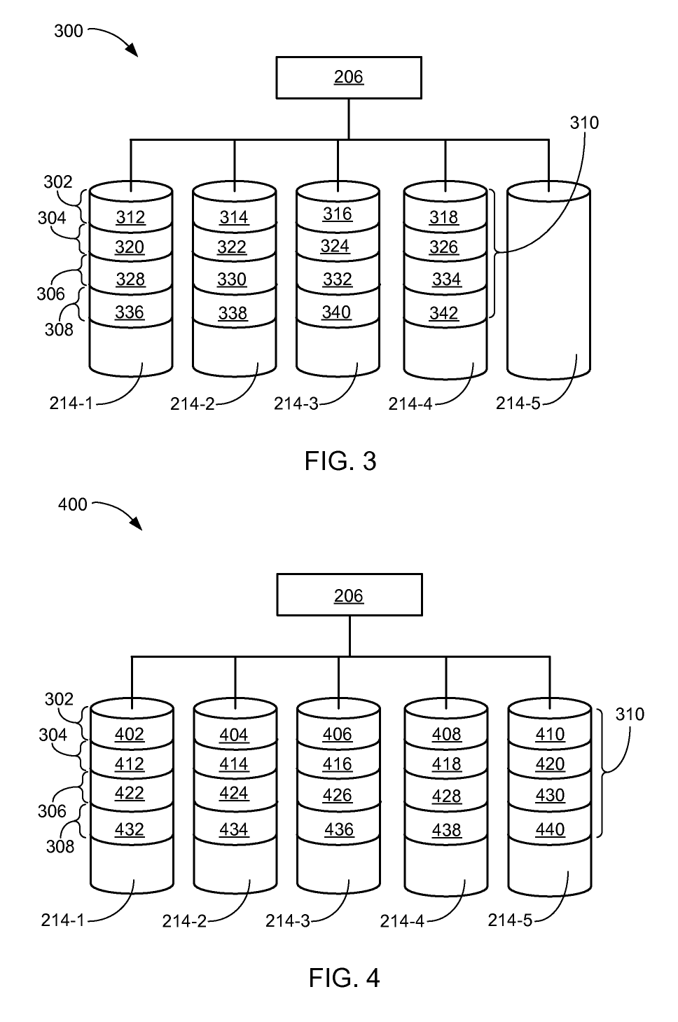

Referring now to FIG. 3 therein is shown a block diagram of a RAID 5 configuration 300 of the data storage system 204, of FIG. 2. The block diagram of the RAID 5 configuration 300 depicts the storage controller 206 coupled to the disk drives 214-1 . . . 5. In the RAID 5 configuration 300, a first logical drive 302, such as a Logical Unit Number (LUN), may be formed by a first group of allocated sectors 312 on the disk drive 214-1, a second group of allocated sectors 314 on the disk drive 214-2, a third group of allocated sectors 316 on the disk drive 214-3, and a fourth group of allocated sectors 318 on the disk drive 214-4. The collective allocated sectors of the first logical drive 302 may be accessed by the host computer system 202, of FIG. 2, as a LUN or a single drive.

A second logical drive 304 may be formed by a fifth group of allocated sectors 320 on the disk drive 214-1, a sixth group of allocated sectors 322 on the disk drive 214-2, a seventh group of allocated sectors 324 on the disk drive 214-3, and an eighth group of allocated sectors 326 on the disk drive 214-4. The collective allocated sectors of the second logical drive 304 may also be called a second LUN.

A third logical drive 306 may be formed by a ninth group of allocated sectors 328 on the disk drive 214-1, a tenth group of allocated sectors 330 on the disk drive 214-2, an eleventh group of allocated sectors 332 on the disk drive 214-3, and a twelfth group of allocated sectors 334 on the disk drive 214-4. The collective allocated sectors of the third logical drive 306 may also be called a third LUN.

A fourth logical drive 308 may be formed by a thirteenth group of allocated sectors 336 on the disk drive 214-1, a fourteenth group of allocated sectors 338 on the disk drive 214-2, a fifteenth group of allocated sectors 340 on the disk drive 214-3, and a sixteenth group of allocated sectors 342 on the disk drive 214-4. The collective allocated sectors of the fourth logical drive 308 may also be called a fourth LUN.

In the RAID 5 configuration 300, logical drives 310, including the first logical drive 302, the second logical drive 304, the third logical drive 306 or the fourth logical drive 308, may have one of the group of allocated sectors dedicated to parity of the data of each of the logical drives 310. It is also customary that parity for each of the logical drives 310 will be found on a different unit of the disk drive 214-1 . . . 4. In the example shown, the first logical drive 302 may have the fourth group of allocated sectors 318 on the disk drive 214-4 for the parity. The second logical drive 304 may have the seventh group of allocated sectors 324 on the disk drive 214-3 for the parity. The third logical drive 306 may have the tenth group of allocated sectors 330 on the disk drive 214-2 for the parity. The fourth logical drive 308 may have the thirteenth group of allocated sectors 336 on the disk drive 214-1 for the parity.

The RAID 5 configuration 300 shown is by way of an example and other configurations and number of the disk drives 214-1 . . . n are possible, including a different number of the logical drives 310. The disk drive 214-5 may be held as an active replacement in case of failure of one of the disk drives 214-1 . . . 4.

In the operation of the RAID 5 configuration 300, the parity is only read if a bad sector is read from one of the disk drives 214-1 . . . n that is storing the actual data. During write operations the parity is always generated and written at the same time as the new data. The un-allocated space on the disk drives 214-1 . . . n may be used to increase the existing size of the logical drive 310 or to allocate an additional member of the logical drive 310.

Referring now to FIG. 4, therein is shown a block diagram of a RAID 6 configuration 400 of the data storage system 204, of FIG. 2. The block diagram of the RAID 6 configuration 400 depicts the storage controller 206 coupled to the disk drives 214-1 . . . 5. In the RAID 6 configuration 400, the data and parity is distributed as in the RAID 5 configuration 300, of FIG. 3, but an additional parity is constructed for each of the logical drives 310. As an example, the first logical drive 302 may have a first data allocation 402 on the disk drive 214-1, a second data allocation 404 on the disk drive 214-2, a third data allocation 406 on the disk drive 214-3, a first parity allocation 408 on the disk drive 214-4, and a second parity allocation 410 on the disk drive 214-5.

The second logical drive 304 may have a first data allocation 412 on the disk drive 214-1, a second data allocation 414 on the disk drive 214-2, a first parity allocation 416 on the disk drive 214-3, a second parity allocation 418 on the disk drive 214-4, and a third data allocation 420 on the disk drive 214-5. The third logical drive 306 may have a first data allocation 422 on the disk drive 214-1, a first parity allocation 424 on the disk drive 214-2, a second parity allocation 426 on the disk drive 214-3, a second data allocation 428 on the disk drive 214-4, and a third data allocation 430 on the disk drive 214-5. The fourth logical drive 308 may have a first parity allocation 432 on the disk drive 214-1, a second parity allocation 434 on the disk drive 214-2, a first data allocation 436 on the disk drive 214-3, a second data allocation 438 on the disk drive 214-4, and a third data allocation 440 on the disk drive 214-5.

The configuration previously described for the RAID 6 configuration 400 is an example only and other configurations are possible. Each of the logical drives 310 must have the first parity allocation 408 and the second parity allocation 410, but they may be located in any of the disk drives 214-1 . . . n. Additionally the example shows five of the disk drives 214-1 . . . n, but a different number of the disk drives 214-1 . . . n may be used.

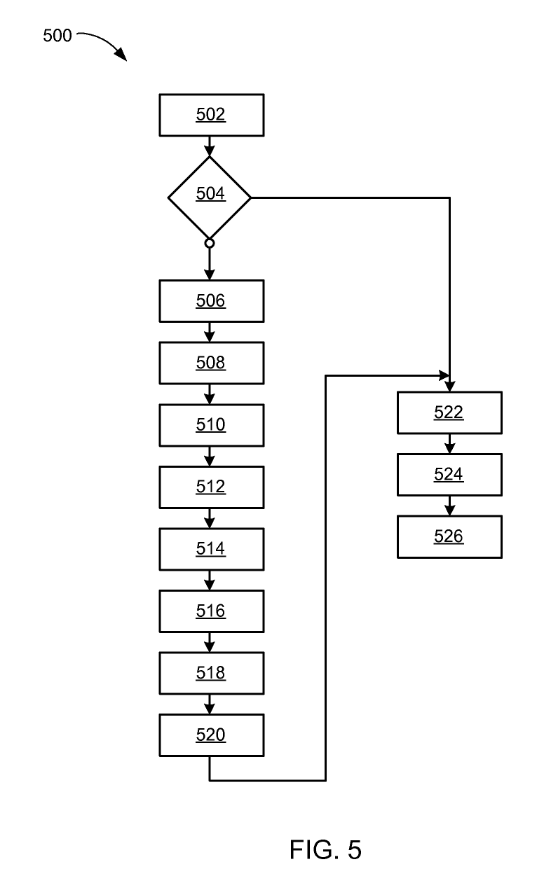

Referring now to FIG. 5, therein is shown a flow chart of a critical logical drive write process 500 for the RAID 5 configuration 300 or the RAID 6 configuration 400. In the operation of the data storage system 204, of FIG. 2, the first logical drive 302, of FIG. 3, may enter a critical state if one of the disk drives 214-1 . . . n fails. The first logical drive 302 will remain in the critical state until all of the data allocations 402 and their associated copies of the parity allocations 408 reside on operational drives. By way of an example, if the disk drive 214-2, of FIG. 3, failed while the storage controller 206, of FIG. 2, was accessing the first logical drive 302, the storage controller 206 would set the first logical drive 302 to the critical state by setting a status bit in a disk data format (DDF) area of each of the disk drives 214-1 . . . n. The DDF area is a reserved area at the end of each physical disk where configuration information for the disk and the system are stored. During the boot-up process the DDF area is read and stored in memory. When a spare unit of the disk drives 214-1 . . . n becomes available, due to the presence of an active replacement or replacement of the disk drive 214-2 that failed in this example, the storage controller 206 may utilize the critical logical drive write process 500 to recover the data.

The flow chart of the critical logical drive write process 500 provides allocating a write-back process 502, in which the data to be written is stored in the RIO 108, of FIG. 1, for a possible delayed write to the disk drives 214-1 . . . n, of FIG. 2. This may also be imperative for recovering from a second failure of the data storage system 204. Prior art storage systems may lose the data to be written if a second failure occurs before the data can be successfully written to the disk drives 214-1 . . . n.

Determining is a parity drive dead 504 will determine the follow-on process. If the answer is yes the parity drive has failed, the flow can proceed to making a write hole table entry 522. If the answer is no the parity drive has not failed, the flow will proceed to allocating a cache resource 506. The allocating of the cache resource 506 may include allocating a resource, for each of the disk drives 214-1 . . . n, to hold parity cache line(s) and data cache lines for the stripe, locking the parity cache line(s), and locking the data cache lines. The cache resource 506 may be locked to prevent any reads or writes to the same area.

The flow proceeds to determining which of a data drive is dead 508 to identify which of the disk drives 214-1 . . . n actually failed. The disk drive 214-1 . . . n that failed is flagged in the R5P structure. The flow then proceeds to computing a dirty bit map 510 for the entire stripe. The term dirty relates to the cache having data to be written for the stripe. If the data is present in the cache, that section is marked as “dirty”, indicating the space should not be reused until the data has been written to the disk drives 214-1 . . . n. Any write data present in the cache from the stripe being processed will be marked as dirty.

The flow proceeds to reading all drives 512, which includes reading from the disk drives 214-1 . . . n any data that is not present in the cache already. This operation includes reading the parity from the disk drive 214-1 . . . n associated with the stripe. At the end of this process step all of the data and parity that is on the disk drive 214-1 . . . n that is operational will be in the cache and marked as valid. It is possible that the data from the disk drive 214-1 . . . n that failed is still in the cache from a previous operation. In this case that data would also be marked as valid.

The flow proceeds to regenerate data and parity 514 which may include regenerating the data for the disk drive 214-1 . . . n that has failed. Any of the data that is not marked as valid in the cache must be regenerated in this process step. The regeneration of data is performed for the failed unit of the disk drive 214-1 . . . n only. The data from the operational units of the disk drives 214-1 . . . n is read directly. New data may be applied to the stripe once all of the data has been regenerated. Applying any new data will require the generation of new parity that will be updated in the cache and marked as dirty.

The flow proceeds to setting a valid bit and dirty bit map 516 which may include setting a valid bit map for all of the cache lines that were read, setting a dirty bit map for the parity cache line, and setting a dirty bit map for the cache line of the disk drive 214-1 . . . n that failed. This process step has aligned all of the data for the new write, indicated that the data is valid and present in the cache, and ready to proceed.

The flow proceeds to releasing a cache resource 518 in which any of the locked cache lines that are not marked as dirty are unlocked. This allows the unlocked cache lines to be used in other operations.

The flow proceeds to releasing an R5P structure 520. This step allows the R5P structure to be used by other operational flows. The R5P structure may be a data structure in memory that contains information about the cache and drive state for each of the physical units of the disk drives 214-1 . . . n.

The flow proceeds to making the write hole table entry 522 in which the information for the pending write of the stripe is entered in the write hole table 120, of FIG. 1, located in the non-volatile memory 114. The write hole table 120 is a fault prevention mechanism. If a power failure occurs prior to the completion of the write, creating a “hole” in the process, the entry in the write hole table 120 will flag the processor 104, of FIG. 1, to complete the operation. In a prior art storage subsystem data could be lost if the storage subsystem was operating in write-back or write-through mode. Many prior art storage subsystems must operate in write-through mode to prevent the possibility of losing data. The write-through mode of operation passes the data directly through to the disk drives 214-1 . . . n and must complete the write before status may be returned to the host computer system 202, of FIG. 2.

It has been discovered that the combination of the write hole table entry 522 and the write-back mode of operation may significantly improve the operational performance of the data storage system 204 without risking data loss due to an untimely loss of power. In the write-back mode of operation, a status may be returned to the host computer system 202 as soon as all of the required data is transferred to the data storage system 204 and the write hole table entry 522 is completed. By removing the latency of the disk drives 214-1 . . . n, the operational performance is increased and the reliability is maintained.

The flow will then proceed to a writing dirty cache lines 524. In this process step, the data from the cache may be transferred to the disk drives 214-1 . . . n. In this process step all of the active and the disk drives 214-1 . . . n associated with this stripe, that are operational, are written at the same time. The data is supplied through the storage system interface 116, of FIG. 1, and the RIO 108. At the successful completion of the write to the disk drives 214-1 . . . n, the flow proceeds to an operational clean-up 526. The operational clean-up may include clearing the write hole table entry 522, clearing the dirty bit map for the data and parity cache lines, and releasing all of the resources in the RIO 108, the storage system interface 116, and the disk drives 214-1 . . . n. This final step may complete the critical logical drive write process 500 for the RAID 5 configuration 300 or the RAID 6 configuration 400.

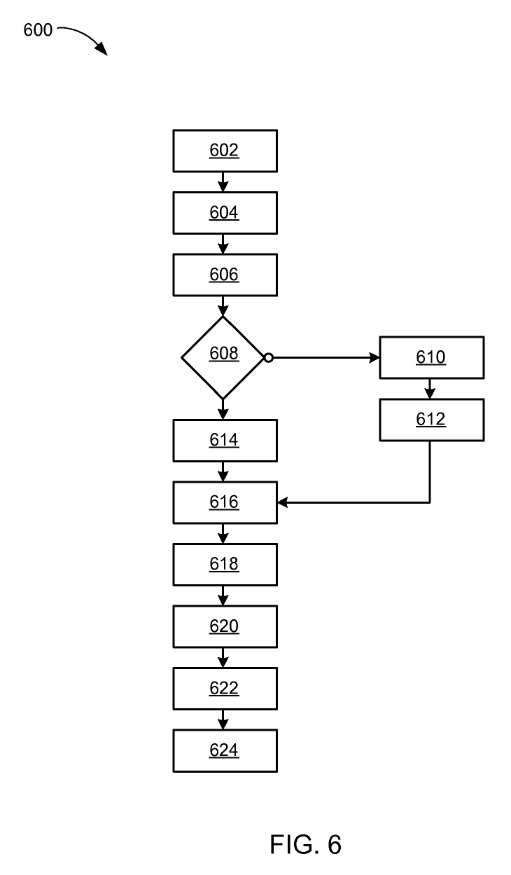

Referring now to FIG. 6, therein is shown a flow chart of a write hole table flush process 600 for the critical logical drive. As an example, the first logical drive 302, of FIG. 3, may be set to a critical state if one of the disk drives 214-1 . . . n, of FIG. 2, fails during or before an operation. While in the critical state, the data storage system 204, of FIG. 2, may be at risk of data loss if a second failure occurs. If there is a power failure or system reboot during a pending write to the first logical drive 302, the write hole table flush process 600 may be invoked to reduce the possibility of data loss. Upon boot-up, the processor 104, of FIG. 1, may detect an entry in the write hole table 120, of FIG. 1, indicating that the write operation was pending. This initiates the write hole table flush process 600.

The flow chart of the write hole table flush process 600 depicts a fetch write hole table entry 602, which may include the processor 104, of FIG. 1, accessing the non-volatile memory 114, of FIG. 1, to retrieve data block information from the write hole table 120. The write hole table 120 may contain all of the information required to complete the pending command.

The flow then proceeds to a set-up write-back process 604. The set-up write-back process 604 may require setting-up the RIO 108, of FIG. 1, including allocating a cache line for the data and enabling a write-back process.

The flow proceeds to a search for dirty cache lines 606, in which the processor 104 may identify any dirty cache lines for the disk drive 214-1 . . . n, of FIG. 2, that has failed. The processor 104 searches for the dirty cache lines because it has detected that the logical drive 310, of FIG. 3, is set to a critical state. This and other information about the pending write operation was retrieved during the fetch write hole table entry 602.

The flow proceeds to a cache line found 608 where a determination is made as to whether the dirty cache lines for the disk drive 214-1 . . . n that has failed have been identified. If no dirty cache lines are detected for the disk drive 214-1 . . . n that has failed, it is an indication that the battery back-up 208, of FIG. 2, may not be installed on the storage controller 206, of FIG. 2, and there not another of the storage controller 206 in the data storage system 204, of FIG. 2. The flow will proceed to a map a stripe 610, where the dirty bit map may be used to identify the full stripe. The dirty bit map may reside in the non-volatile memory 114. Its contents will indicate which blocks are included in the logical drive 310 that cannot now be written.

The flow then proceeds to a mark block 612, where the data of the disk drive 214-1 . . . n that failed will be scrubbed by mapping a known data pattern to the cache and using the scrubbed data, recomputed the parity for the stripe and save it in the cache. The block of data that was scrubbed is entered into a read check table in the non-volatile memory 114, so that a “medium error” may be reported any time these blocks are read without accessing the disk drive 214-1 . . . n that failed. The medium error will persist until the scrubbed blocks are once again written by the host computer system, 202, of FIG. 2. The flow will then proceed to an allocate stripe 616 for further processing.

If the dirty cache lines are detected in the cache line found 608, the flow will proceed to a dirty bit map 614, in which the dirty bit map may be used for determining which cache lines are used for generating parity for the stripe. Since all of the data from the disk drive 214-1 . . . n that failed is determined to be in the cache, the parity generation can complete normally.

The flow then proceeds to the allocate stripe 616, where cache lines are allocated for all of the disk drives 214-1 . . . n that are in the stripe, in preparation for entering a read data 618. In the read data 618, any data from the stripe that is not already in the RIO 108 must be read from the disk drives 214-1 . . . n associated with the stripe. If all of the stripe data resides in the RIO 108, no read of the disk drives 214-1 . . . n is necessary.

The flow proceeds to a compute new parity 620, in which all of the stripe data may be supplied to the XOR engine 112, of FIG. 1, for generating the new parity for the stripe. The flow then proceeds to a write stripe 622, where the data in the RIO 108 is written to the disk drives 214-1 . . . n associated with the stripe including the parity. The flow proceeds to an end of write 624, where all of the RIO 108 and the storage system interface 116 resources are released.

It has been discovered that the combination of the battery back-up 208 and the use of the write hole table 120 may recover data that would have been lost in the prior art storage system. While the prior art storage system may have regenerated the data prior to a second failure, the data in the cache was not marked as dirty because it did not come from the host computer system 104. A power failure prior to the completion of the write of the regenerated data would result in the data being lost. The present invention provides protection by setting the dirty bit status of the regenerated data and preserving the data through the power failure. Since the parity and the data on all of the functional drives have been written correctly, the data that should be on the disk drive 214-1 . . . n, which failed, can be regenerated in a later operation. A prior art data storage subsystem may have no option but to indicate a medium error for the logical drives 310 associated with the disk drive 214-1 . . . n that failed.

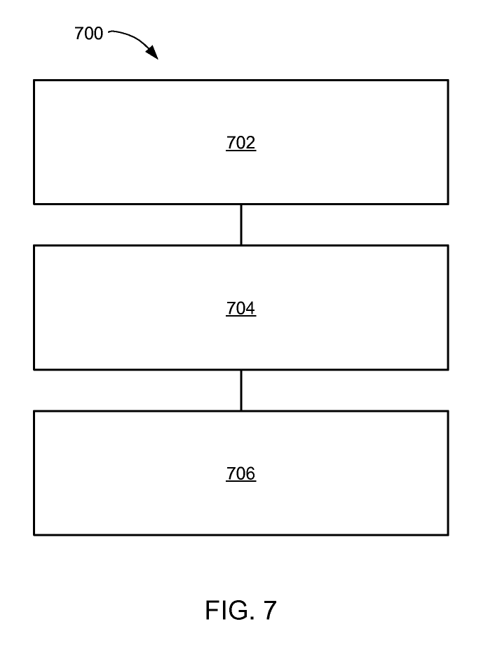

Referring now to FIG. 7, therein is shown a flow chart of a redundant array of independent disks write recovery system 700 for operating the redundant array of independent disks write recovery system 100 in an embodiment of the present invention. The system 700 includes providing a logical drive having a disk drive that failed in a block 702; rebooting a storage controller, coupled to the disk drive, after a controller error in a block 704; and reading a write hole table, in the storage controller, for regenerating data on the logical drive in a block 706.

It has been discovered that the present invention thus has numerous aspects.

A principle aspect that has been discovered is that the present invention may provide better system performance while maintaining the system reliability. This is achieved by releasing the system status, on a write command, as soon as the data is stored in memory and the command is entered in the write hole table. This process in effect removes the latency of accessing the disk drives from the command execution. This combination may save in the range of 10 to 100 milli-seconds per write command.

Another aspect is data integrity may be maintained on a RAID 5 or RAID 6 configuration even when a second failure occurs on a critical logical drive.

Yet another important aspect of the present invention is that it valuably supports and services the historical trend of reducing costs, simplifying systems, and increasing performance.

These and other valuable aspects of the present invention consequently further the state of the technology to at least the next level.

Thus, it has been discovered that the redundant array of independent disks write recovery system of the present invention furnishes important and heretofore unknown and unavailable solutions, capabilities, and functional aspects for increasing performance and maintaining data integrity in RAID 5 and RAID 6 configurations. The resulting processes and configurations are straightforward, cost-effective, uncomplicated, highly versatile and effective, can be surprisingly and unobviously implemented by adapting known technologies, fully compatible with conventional manufacturing processes and technologies. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A redundant array of independent disks write recovery system including:
providing a logical drive having a disk drive that failed;
rebooting a storage controller, coupled to the disk drive, after a controller error; and
reading a write hole table, in the storage controller, for regenerating data on the logical drive.

2. The system as claimed in claim 1 further comprising providing a non-volatile memory, in the storage controller, for storing the write hole table.

3. The system as claimed in claim 1 further comprising:
providing a processor in the storage controller;
initializing a RAM input/output cache file by the processor; and
coupling a storage system interface to the RAM input/output cache file for transferring the data to the logical drive.

4. The system as claimed in claim 1 further comprising coupling a battery back-up on the storage controller for preserving the data during the controller error.

5. The system as claimed in claim 1 wherein rebooting the storage controller includes:
starting a processor;
reading a write hole table entry by the processor;
searching a RAM input/output cache file for the data from the disk drive that failed; and
reading a dirty bit map by the processor for the data found in the RAM input/output cache file.

6. A redundant array of independent disks write recovery system including:
providing a logical drive having a disk drive that failed including having a RAID 5 configuration or a RAID 6 configuration on the logical drive;
rebooting a storage controller, coupled to the disk drive, after a controller error; and
reading a write hole table, in the storage controller, for regenerating data on the logical drive including enabling an XOR engine for regenerating the data on the disk drive that failed.

7. The system as claimed in claim 6 further comprising providing a non-volatile memory, in the storage controller, for storing the write hole table including finding a write hole table entry for the logical drive.

8. The system as claimed in claim 6 further comprising:
providing a processor in the storage controller including coupling a battery back-up interface to the processor;
initializing a RAM input/output cache file by the processor including reading a non-volatile memory for locating a dirty bit map; and
coupling a storage system interface to the RAM input/output cache file for transferring the data to the logical drive including enabling cache lines based on the dirty bit map.

9. The system as claimed in claim 6 further comprising coupling a battery back-up on the storage controller for preserving the data during the controller error including providing a processor, a host computer interface, the RAM input/output cache file, the XOR engine, a memory interface, a storage system interface, or a combination thereof with a sustaining power.

10. The system as claimed in claim 6 wherein rebooting the storage controller includes:
starting a processor including reading a non-volatile memory for determining the state of the logical drive;
reading a write hole table entry by the processor including determining a write command is pending for the logical drive;
searching a RAM input/output cache file for the data from the disk drive that failed including reading a dirty bit map from the non-volatile memory; and
wherein:
reading the dirty bit map by the processor for the data found in the RAM input/output cache file including reading the data from the logical drive for the disk drives not in the dirty bit map.

11. A redundant array of independent disks write recovery system including:
a logical drive with a disk drive that failed;
a storage controller, coupled to the disk drive, after a controller error; and
a write hole table read, in the storage controller, for regenerating data on the logical drive.

12. The system as claimed in claim 11 further comprising a non-volatile memory, in the storage controller, with the write hole table stored.

13. The system as claimed in claim 11 further comprising:
a processor in the storage controller;
a RAM input/output cache file coupled to the processor; and
a storage system interface coupled between the RAM input/output cache file and the logical drive.

14. The system as claimed in claim 11 further comprising a battery back-up on the storage controller for preserving the data during the controller error.

15. The system as claimed in claim 11 wherein the storage controller coupled to the disk drive includes:
a processor for reading a write hole table entry;
a RAM input/output cache file with the data from the disk drive that failed; and
an XOR engine coupled between the processor and the RAM input/output cache file.

16. The system as claimed in claim 11 further comprising:
a RAID 5 configuration or a RAID 6 configuration on the logical drive; and
an XOR engine for regenerating the data on the disk drive that failed.

17. The system as claimed in claim 16 further comprising a non-volatile memory, in the storage controller, with the write hole table stored includes a write hole table entry for the logical drive.

18. The system as claimed in claim 16 further comprising:
a processor in the storage controller includes a battery back-up interface coupled to the processor;
a RAM input/output cache file coupled to the processor includes a non-volatile memory for locating a dirty bit map; and
a storage system interface coupled between the RAM input/output cache file and the logical drive includes cache lines enabled by the dirty bit map.

19. The system as claimed in claim 16 further comprising a battery back-up on the storage controller for preserving the data during the controller error includes a processor, a host computer interface, the RAM input/output cache file, the XOR engine, a memory interface, a storage system interface, or a combination thereof coupled to the battery back-up.

20. The system as claimed in claim 16 wherein the storage controller coupled to the disk drive includes:
a processor for reading a write hole table entry includes a state of the logical drive stored in a non-volatile memory;
a RAM input/output cache file with the data from the disk drive that failed includes a dirty bit map in the non-volatile memory; and
wherein:
the XOR engine coupled between the processor and the RAM input/output cache file includes a storage system interface between the RAM input/output cache file and the logical drives.
